(19) United States
(12) Patent Application Publication
(10) Pub. No.: US 2023/0284245 A1
(43) Pub. Date: Sep. 7, 2023

(54) SIDELINK METHOD AND APPARATUS, AND STORAGE MEDIUM

(71) Applicant: BEIJING XIAOMI MOBILE SOFTWARE CO., LTD., Beijing (CN)

(72) Inventor: Qun ZHAO, Beijing (CN)

(73) Assignee: BEIJING XIAOMI MOBILE SOFTWARE CO., LTD., Beijing (CN)

(21) Appl. No.: 18/011,472

(22) PCT Filed: Jun. 17, 2020
(86) PCT No.: PCT/CN2020/096651

§ 371 Date: Dec. 19, 2022

(51) Int. Cl. H04W 72/40; H04W 72/02; H04W 28/02

(52) U.S. Cl. CPC H04W 72/40; H04W 72/02; H04W 28/0252

(57) ABSTRACT

Disclosed is a sidelink method, belonging to the technical field of wireless communications. The method includes: a first terminal obtaining a channel congestion condition and selecting a sidelink strategy based on the channel congestion condition, where the sidelink strategy is associated with sensing and/or selecting a sidelink resource.

### CROSS-REFERENCE TO RELATED APPLICATION

The present application is the U.S. National phase application of International Application No. PCT/CN2020/096651, filed on Jun. 17, 2020, the entire content of which is incorporated herein by reference for all purposes.

### TECHNICAL FIELD

The present disclosure relates to the field of wireless communication technology, and in particular, to a sidelink method, apparatus, and storage medium.

### BACKGROUND

Sidelink is a near-field communication technology in which terminals are directly connected to each other through wireless interfaces.

In related art, in order to avoid mutual interference, the terminal senses in the sensing window prior to the sidelink transmission and selects the communication resource which is idle in sensing result for sidelink transmission. However, this scheme requires the terminal to continuously sense the channel, which requires a large amount of power consumption at the terminal.

### SUMMARY

The present disclosure provides a sidelink method, apparatus, and storage medium. The technical solutions are described as follows.

According to a first aspect of the present disclosure, there is provided a sidelink method. The method is performed by a first terminal and the method includes:
obtaining a channel congestion condition; and
selecting a sidelink strategy based on the channel congestion condition, wherein the sidelink strategy is associated with sensing and/or selecting a sidelink resource.

According to a second aspect of the present disclosure, there is provided a congestion control method for sidelink. The method is performed by a first terminal and the method includes:
determining a sidelink strategy, the sidelink strategy being associated with sensing and/or selecting a sidelink resource; and
determining a limitation on a value of a sidelink data transmission parameter based on the sidelink strategy.

According to a third aspect of the present disclosure, there is provided a sidelink method. The method is performed by a network device and the method includes:
obtaining a channel congestion condition; and
sending the channel congestion condition to a first terminal for determining a sidelink strategy, the sidelink strategy being associated with sensing and/or selecting a sidelink resource.

According to a fourth aspect of the present disclosure, there is provided a sidelink device. The device is used in a first terminal and the device includes:
a processor, and
a memory for storing instructions executable by the processor;
where the processor is configured to:
obtain a channel congestion condition; and
select a sidelink strategy based on the channel congestion condition, wherein the sidelink strategy is associated with sensing and/or selecting a sidelink resource.

According to a fifth aspect of the present disclosure, there is provided a congestion control device for sidelink. The device is used in a first terminal and the device includes:
a processor, and
a memory for storing instructions executable by the processor;
where the processor is configured to:
determine a sidelink strategy, the sidelink strategy being associated with sensing and/or selecting a sidelink resource; and
determine a limitation on a value of a sidelink data transmission parameter based on the sidelink strategy.

According to a sixth aspect of the present disclosure, there is provided a sidelink device. The device is used in a network device and the device includes:
a processor, and
a memory for storing instructions executable by the processor;
where the processor is configured to:
obtain a channel congestion condition; and
send the channel congestion condition to a first terminal for determining a sidelink strategy, the sidelink strategy being associated with sensing and/or selecting a sidelink resource.

According to a seventh aspect of the present disclosure, there is provided a non-transitory computer-readable storage medium. The computer-readable storage medium has executable instructions stored thereon, which are invoked by a processor in a communication device to implement the methods described above.

According to an eight aspect of the present disclosure, there is provided a computer program product. The computer program product includes computer instructions stored on a computer-readable storage medium. A processor of a communication device can read the computer instructions from the computer-readable storage medium and executes the computer instructions to make the communication device implements the methods described above.

It should be understood that the foregoing general description and the following detailed descriptions are exemplary only and do not limit the present disclosure.

### BRIEF DESCRIPTION OF THE DRAWINGS

The accompanying drawings herein, which are incorporated into and constitute a part of this specification, illustrate embodiments consistent with the present disclosure, and are used in conjunction with the specification to explain the principles of the present disclosure.

FIG. 1 is a schematic diagram of an implementation environment provided in accordance with an exemplary embodiment.

FIG. 2 is a flowchart of a sidelink method illustrated in accordance with an exemplary embodiment.

FIG. 3 is a flowchart of a congestion control method for sidelink illustrated in accordance with an exemplary embodiment.

FIG. 4 is a flowchart of a sidelink method illustrated in accordance with an exemplary embodiment.

FIG. 5 is a flowchart of a sidelink method illustrated in accordance with an exemplary embodiment.

FIG. 6 is a block diagram of a sidelink apparatus illustrated in accordance with an exemplary embodiment.

FIG. 7 is a block diagram of a congestion control apparatus for sidelink illustrated in accordance with an exemplary embodiment.

FIG. 8 is a block diagram of a sidelink apparatus illustrated in accordance with an exemplary embodiment.

FIG. 9 is a schematic diagram of the structure of a terminal illustrated in accordance with an exemplary embodiment.

FIG. 10 is a schematic diagram of the structure of a network device illustrated in accordance with an exemplary embodiment.

### DETAILED DESCRIPTION

Exemplary embodiments will be described herein in detail, examples of which are shown in the accompanying drawings. When the following description relates to the accompanying drawings, the same numerals in the different accompanying drawings indicate the same or similar elements unless otherwise indicated. The implementations described in the following exemplary embodiments do not represent all implementations that are consistent with the present disclosure. Rather, they are only examples of devices and methods that are consistent with some aspects of embodiments of the present disclosure as detailed in the appended claims.

It should be understood that the word “several” in this document refers to one or more, while the phrase “multiple of,” or “a plurality of” refers to two or more. The word “and/or” describes the relationship of the associated objects, indicating that there can be three kinds of relationships, for example, A and/or B can indicate three cases, i.e., the existence of A alone, both A and B, and the existence of B alone. The character “/” generally indicates that the relationship between the associated objects before and after the character “/” is an “or” relationship.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

The emergence of a new generation of new Internet of Things (IoT) applications is placing higher demands on wireless communication technologies, driving the evolution of wireless communication technologies to meet the needs of the applications. Vehicle to Everything communication is one of the applications that need to be supported by the development of cellular wireless communication networks today.

Vehicle to Everything (V2X) includes Vehicle to Vehicle (V2V), Vehicle to Infrastructure (V2I) and Vehicle to Pedestrian (V2P) services. By supporting V2V, V2I and V2P communications, V2X can effectively enhance traffic safety, improve traffic efficiency and enrich people's travel experience. The use of existing cellular communication technologies to support V2X communications can effectively utilize existing base station deployments, reduce equipment overhead, and facilitate the provision of services with Quality of Service (QoS) guarantees to meet the needs of V2X services. Therefore, Long Term Evolution (LTE) Rel-14/15 provides support for V2X communications via cellular networks, i.e., Cellular Based V2x (C-V2x). In C-V2x technology, the communication between vehicle UE and other devices can be relayed through the base station and core network, i.e., using the communication link between the terminal device and the base station in the original cellular network for communication (uplink/downlink communication) or directly through the sidelink between devices for communication (i.e., sidelink communication). Compared with communications via Uu interfaces, the sidelink communication has the characteristics of short delay and low overhead, which is ideal for direct communication between vehicle UE and other peripheral devices in close geographical proximity.

V2X sidelink communication in LTE can only support some basic V2x applications for security, such as voice broadcast communication with Cooperative Awareness Messages (CAM), Decentralized Environmental Notification Message (DENM) and other Basic Safety Message (BSM). Recently, with the development of technologies such as autonomous driving, new requirements have been placed on the performance of V2x technology to support new V2x services. The use of the 5th Generation Mobile Communication (5G), also known as New Radio (NR), to support new V2x communication services and scenarios has been planned by the 3rd Generation Partnership Project (3GPP) as an important element of Rel16. The 3GPP SA1 (Service Requirement) working group has proposed a number of business requirements that need to be met for new V2x communications, including Vehicles Platooning, Extended Sensors, Advanced Driving, and Remote Driving. In general, there is a need for NR V2x sidelink to provide higher communication rate, shorter communication delay, and more reliable communication quality. However, in current 5G V2x technology, communication between vehicle terminals is mainly considered, and not much consideration is given to the needs of handheld terminals and other terminal forms, such as power saving.

Both LTE V2x and 5G V2x rely on the sensing of terminals to reduce the interference between neighboring terminals, i.e., to avoid terminals that interfere with each other from selecting the same time or frequency resources for sidelink transmission. The terminal needs to continuously senses the resource reservation information of other user devices in the sensing window prior to resource selection, and perform the corresponding measurement operation to remove those time or frequency resources with high expected interference from the resource selection window according to the resource reservation information and measurement value, and then the terminal selects the time or frequency resources used for the final sidelink transmission among the remaining time or frequency resources.

However, continuous sensing will cause a lot of power consumption, which result in failure to meet the deployment requirements on terminals with high power requirements. In addition, on the basis of energy saving, it is necessary to consider guaranteeing sufficient sensing for sidelink communication. Therefore, the solution shown in the following embodiments of this application provide a sidelink data transmission scheme that can reduce power consumption.

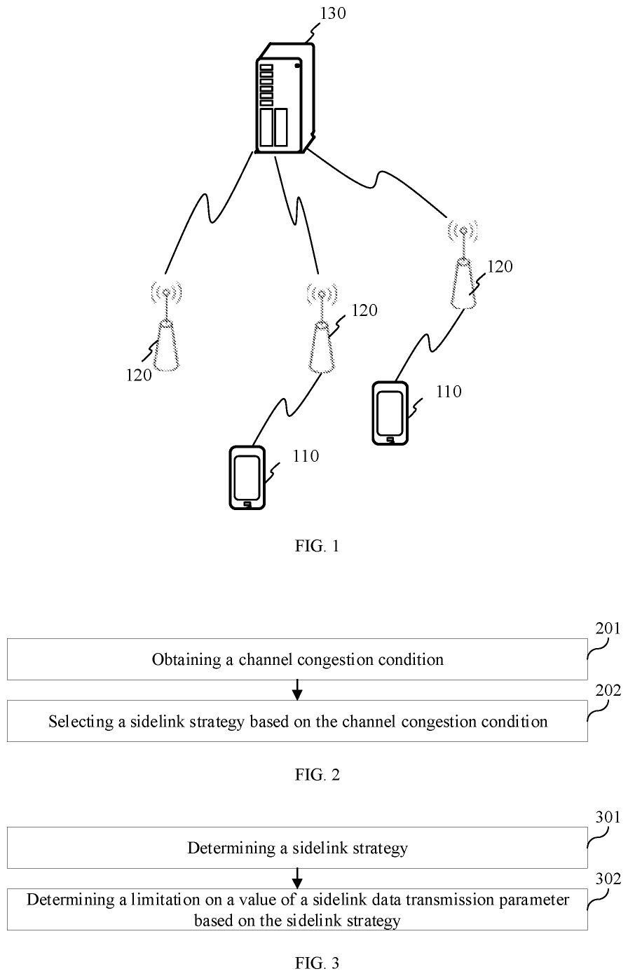

FIG. 1 is a schematic diagram of an implementation environment involved in a sidelink method illustrated in accordance with some exemplary embodiments. As shown in FIG. 1, the implementation environment may include a plurality of terminals 110 and base stations 120.

Terminal 110 is a wireless communication device that supports multiple wireless access technologies for sidelink transmission. For example, terminal 110 can support cellular mobile communication technology, or, fifth-generation mobile communication technology. Alternatively, terminal 110 can also support a further next-generation mobile communication technology of 5G technology.

For example, terminal 110 may be vehicle UE, for example, a trip computer with wireless communication functions, or a wireless communication device external to the trip computer.

Alternatively, terminal 110 may be Road-Side Unit (RSU) equipment, for example, it may be a street light, signal light or other RSU equipment with wireless communication functions.

Alternatively, terminal 110 may be subscriber terminal equipment, such as a cellphone (or “cellular” phone) and a computer with a mobile terminal, for example, a portable, pocket-sized, handheld, computer-built, or vehicle-mounted mobile device. For example, it may be a Station (STA), Subscriber Unit, Subscriber Station, Mobile Station, Mobile, Remote Station, Access Point, Remote Terminal, Access Terminal, User Terminal, User Agent, User Device, or User Equipment (UE). Specifically, for example, terminal 110 can be a mobile terminal such as a smartphone, a tablet computer, an e-book reader, or, can be a smart wearable device such as smart glasses, a smart watch, or a smart bracelet.

Base station 120 may be a network side device in a wireless communication system. Here, the wireless communication system may also be a 5G system, also known as a New Radio (NR) system. Alternatively, the wireless communication system may also be a further next-generation or multi-generation system of the 5G system.

Among others, base station 120 may be a base station (gNB) in a 5G system using a centralized distributed architecture. When the base station 120 adopts a centralized distributed architecture, it usually includes a Centralized Unit (CU) and at least two Distributed Units (DUs). The CU is provided with a protocol stack of Packet Data Convergence Protocol (PDCP) layer, Radio Link Control (RLC) layer, and Media Access Control (MAC) layer. The DU is provided-with a protocol stack of Physical (PHY) layer. The specific implementations of the base station 120 are not limited in the embodiments of this disclosure.

A wireless connection can be established between the base station 120 and the terminal 110 via a wireless air interface. The wireless air interface is based on the fifth generation mobile communication network technology (5G) standard, for example, the wireless air interface is New Radio (NR), or the wireless air interface may also be based on a further next generation mobile communication network technology standard of 5G.

Alternatively, the above wireless communication system may also include a network management device 130.

A number of base stations 120 are each connected to a network management device 130. The network management device 130 may be a core network device in the wireless communication system, for example, the network management device 130 may be a Mobility Management Entity (MME) in an Evolved Packet Core (EPC) network. Alternatively, the network management device may be other core network devices, such as a Serving GateWay (SGW), Public Data Network GateWay (PGW), Policy and Charging Rules Function (PCRF), or Home Subscriber Server (HSS), etc. The implementation form of the network management device 130 is not limited by the embodiments of the present disclosure.

FIG. 2 is a flowchart of a sidelink method illustrated in accordance with an exemplary embodiment. The sidelink method can be performed by a first terminal. For example, the first terminal may be a terminal 110 in the implementation environment shown in FIG. 1. As shown in FIG. 2, the method may include the following steps.

Step 201, obtaining a channel congestion condition.

In one example, the channel congestion condition is used to indicate a measurement value of a Channel Busy Ratio (CBR). The channel congestion condition may refer to a congestion condition of a sidelink channel associated with the first terminal.

Step 202, selecting a sidelink strategy based on the channel congestion condition, where the sidelink strategy is associated with sensing and/or selecting a sidelink resource.

In one example, the sidelink strategy is a strategy for selecting resources for sidelink. The sidelink strategy includes a first sidelink strategy and/or a second sidelink strategy. The resources being sensed under the first sidelink strategy are less than the resources being sensed under the second sidelink strategy.

Taking the channel congestion condition as an indication of the channel busy ratio for example, when the measurement value of CBR is low, it means that within a range near the terminal, the proportion of occupied channels for sidelink is low and most of the channels are not occupied, so the probability of interference between neighboring terminals is low, or the probability for selecting the same time/frequency resources by neighboring terminals for sidelink transmission is low. Even if the terminal only senses a small number of resources or even no sensing in order to save energy, there is a higher probability of selecting resources suitable for sidelink transmission and not causing excessive deterioration of system performance. In this case, the terminal can choose the first sidelink strategy as the sidelink strategy, so that the terminal can select the sidelink resources either by sensing a small number of resources or by not sensing, in order to save power consumption of the terminal.

When the measurement value of CBR is high, it indicates that the proportion of channels occupied for sidelink is high within a range near the terminal, and most of the channels are occupied, so the terminal needs to perform complete channel sensing to determine the location of the time/frequency resources reserved by other neighboring terminals and avoid possible interference, otherwise it may select the time/frequency resources with strong interference and cause a large impact on the system performance. In this case, the terminal can select the second sidelink strategy as the sidelink strategy, so that the terminal can select a target sidelink resource in case of sensing most or all of the resources to ensure that a suitable sidelink resource can be selected to avoid resource collision.

In one example, said selecting the sidelink strategy based on the channel congestion condition includes:
selecting the sidelink strategy based on a relationship between the channel congestion condition and a congestion threshold.

In one example, the first sidelink strategy is selected in response to the channel congestion condition not reaching a congestion threshold; or,
the second sidelink strategy is selected in response to the channel congestion condition reaching a congestion threshold.

Here, the resources being sensed under the first sidelink strategy are less than the resources being sensed under the second sidelink strategy.

In one example, the channel congestion condition is obtained by performing a CBR measurement on at least one specified channel.

In one example, the channel congestion condition is obtained by a measurement of a network device; and
said obtaining the channel congestion condition includes:
receiving the channel congestion condition from the network device.

In one example, the channel congestion condition includes an indicator of the sidelink strategy for the first terminal.

In one example, when the network device is a base station, said receiving the channel congestion condition from the network device includes:
receiving the channel congestion condition sent by the base station via first signaling, the first signaling including at least one of a radio resource control (RRC) signaling and downlink control information (DCI).

In one example, when the network device is a second terminal, said receiving the channel congestion condition from the network device includes:
receiving the channel congestion condition sent by the second terminal via second signaling, the second signaling including at least one of Physical layer control information for sidelink, MAC layer control information for sidelink, and RRC layer control information for sidelink.

In one example, the method further includes:
obtaining the congestion threshold set in advance;
or,
receiving downlink signaling from a base station and obtaining the congestion threshold based on the downlink signaling.

In one example, the method further includes:
selecting a corresponding congestion threshold based on a priority of sidelink data to be sent from the first terminal.

In one example, the method further includes:
obtaining a predetermined correspondence between the priority and the congestion threshold;
or,
receiving downlink signaling from the base station and obtaining a correspondence between the priority and the congestion threshold based on the downlink signaling.

In one example, the method further includes:
obtaining a measurement configuration parameter, the measurement configuration parameter being used to indicate timing of the CBR measurement; and
performing the CBR measurement according to the timing of the CBR measurement.

In one example, the first sidelink strategy includes:
sensing part of resources in a sidelink resource pool, and selecting a target sidelink resource from the part of resources based on a sensing result;
or,
randomly selecting a target sidelink resource from a sidelink resource pool.

In view of above, in the scheme described in the embodiments of the present application, the terminal selects, based on the channel congestion condition, a sidelink strategy from two sidelink strategies with different amounts of resources sensed, so as to subsequently select resources for sidelink based on the selected strategy. That is, by using the above scheme, the terminal can be indicated through the channel congestion condition to use the sidelink modes with different amounts of resources sensed. Since the less resources are sensed, the corresponding power consumption of sensing is lower, the above scheme can reduce the power consumption of the terminal during sidelink transmission while avoiding channel collisions as much as possible.

FIG. 3 is a flowchart of a congestion control method for sidelink illustrated in accordance with an exemplary embodiment. The congestion control method for sidelink can be performed by a first terminal. For example, the first terminal may be a terminal 110 in the implementation environment shown in FIG. 1. As shown in FIG. 3, the method may include the following steps.

Step 301, determining a sidelink strategy, the sidelink strategy being associated with sensing and/or selecting a sidelink resource.

In one example, the sidelink strategy is a strategy for selecting resources for sidelink. The sidelink strategy includes a first sidelink strategy and/or a second sidelink strategy. The resources being sensed under the first sidelink strategy are less than the resources being sensed under the second sidelink strategy.

Step 302, determining a limitation on a value of a sidelink data transmission parameter based on the sidelink strategy.

In one example, the sidelink strategy includes a first sidelink strategy and/or a second sidelink strategy. The resources being sensed under the first sidelink strategy are less than the resources being sensed under the second sidelink strategy.

In one example, a communication resource is selected for sidelink transmission based on the sidelink strategy.

The communication resource includes at least one of a time resource, a frequency resource, and a port resource.

In one example, said determining the limitation on the value of the sidelink data transmission parameter based on the sidelink strategy, includes:
determining a transmission parameter mapping relationship based on the sidelink strategy, the transmission parameter mapping relationship including a correspondence between the channel congestion condition and the limitation on the value of the sidelink data transmission parameter; and
querying the transmission parameter mapping relationship and obtaining the limitation on the value of the sidelink data transmission parameter that corresponds to the channel congestion condition.

In one example, the method further includes:
receiving downlink signaling from a base station, and obtaining the transmission parameter mapping relationship based on the downlink signaling.

In one example, the limitation on the value of the sidelink data transmission parameter includes at least one of:
a maximum allowed transmitting power;
an available modulation coding method;
a maximum number of time resources and/or frequency resources occupied by a single transmission;
a maximum number of times for retransmission of a data block; and
an upper limit of a Channel Occupancy Ratio (CR).

In view of above, in the scheme described in the embodiments of the present application, the terminal selects, based on the channel congestion condition, a sidelink strategy from two sidelink strategies with different amounts of resources sensed, so as to subsequently select resources for sidelink based on the selected strategy. That is, by using the above scheme, the terminal can be indicated through the channel congestion condition to use the sidelink modes with different amounts of resources sensed. Since the less resources are sensed, the corresponding power consumption of sensing is lower, the above scheme can reduce the power consumption of the terminal during sidelink transmission while avoiding channel collisions as much as possible.

In the above scheme shown in FIG. 2, the channel congestion condition may be measured and generated by the CBR measurement at the first terminal itself, or may be measured and generated by a network device other than the first terminal. When the channel congestion condition is generated by the network device, the steps of the scheme performed by the network device are described as follows.

FIG. 4 is a flowchart of a sidelink method illustrated in accordance with an exemplary embodiment. The sidelink method can be performed by a network device, for example, the network device may be a terminal 110 or a base station 120 in the implementation environment shown in FIG. 1. As shown in FIG. 4, the method may include the following steps.

Step 401, obtaining a channel congestion condition.

In one example, the above-mentioned performing channel congestion condition measurement refers to performing the CBR measurement, obtaining a CBR measurement value, and generating the channel congestion condition based on the CBR measurement value. The channel congestion condition may refer to a congestion condition of a sidelink associated with the first terminal.

In another example, the channel congestion condition may also be sent to the network device by the terminal after the terminal performing the channel congestion condition measurement. For example, when the network device is a base station, the channel congestion condition may be reported to the base station by a second terminal other than the first terminal after the second terminal performing the channel congestion condition measurement.

Step 402, sending the channel congestion condition to the first terminal for determining a sidelink strategy, the sidelink strategy being associated with sensing and/or selecting a sidelink resource.

In one example, the channel congestion condition includes an indicator of the sidelink strategy for the first terminal. The sidelink strategy includes a first sidelink strategy and/or a second sidelink strategy. The resources being sensed under the first sidelink strategy are less than the resources being sensed under the second sidelink strategy.

In one example, the channel congestion condition is obtained by performing a CBR measurement on at least one specified channel.

In one example, the network device is a base station, and said sending the channel congestion condition to the first terminal for determining the sidelink strategy, the sidelink strategy being associated with sensing and/or selecting the sidelink resource, includes:
sending the channel congestion condition to the first terminal via first signaling, the first signaling including at least one of a radio resource control (RRC) signaling and downlink control information (DCI).

In one example, the network device is a second terminal, said sending the channel congestion condition to the first terminal for determining the sidelink strategy, the sidelink strategy being associated with sensing and/or selecting the sidelink resource, includes:
sending the channel congestion condition to the first terminal via second signaling, the second signaling including at least one of Physical layer control information for sidelink, MAC layer control information for sidelink, and RRC layer control information for sidelink.

In one example, the network device is a base station, and the method further includes:
sending a congestion threshold to the first terminal via downlink signaling.

In one example, the network device is a base station, and the method further includes:
sending the first terminal a correspondence between a priority and a congestion threshold via downlink signaling, where the priority is a priority of sidelink data to be sent from the first terminal.

In one example, the network device is a base station, and the method further includes:
sending the first terminal a measurement configuration parameter via downlink signaling, the measurement configuration parameter being used to indicate to the first terminal timing of the CBR measurement.

In one example, the network device is a base station, and the method further includes:
sending the first terminal a transmission parameter mapping relationship corresponding to the sidelink strategy via downlink signaling.

In view of above, in the scheme described in the embodiments of the present application, the terminal selects, based on the channel congestion condition, a sidelink strategy from two sidelink strategies with different amounts of resources sensed, so as to subsequently select resources for sidelink based on the selected strategy. That is, by using the above scheme, the terminal can be indicated through the channel congestion condition to use the sidelink modes with different amounts of resources sensed. Since the less resources are sensed, the corresponding power consumption of sensing is lower, the above scheme can reduce the power consumption of the terminal during sidelink transmission while avoiding channel collisions as much as possible.

FIG. 5 is a flowchart of a sidelink method illustrated in accordance with an exemplary embodiment. The sidelink method can be performed interactively by a first terminal and a network device, for example, the terminal may be a terminal 110 in the implementation environment shown in FIG. 1, and the network device may be another terminal 110 of the implementation environment shown in FIG. 1 or a base station 120. As shown in FIG. 5, the method may include the following steps.

Step 501, obtaining, by the network device, a channel congestion condition.

In one example, the network device performs a channel congestion condition measurement to obtain the channel congestion condition.

In one example, the network device performs a CBR measurement and obtains a CBR measurement value.

Here, the network device is a base station or a second terminal.

In one example, when the network device is a base station, the base station is a base station corresponding to a service cell of the first terminal, or, the base station is a base station closest to the first terminal.

In one example, when the network device is a second terminal, the second terminal is a terminal that is within a specified range around the first terminal.

Here, the second terminal is a subscriber terminal, or the second terminal is a non-subscriber terminal, e.g., Road-Side Unit (RSU) equipment in a V2X system.

Taking the channel congestion condition including the CBR measurement value, or the channel congestion condition being generated based on the CBR measurement value, as an example, in the embodiments of this application, when the second terminal is within a specified range around the first terminal (e.g., a distance between the first terminal and the second terminal is less than a predetermined threshold), the wireless environment around the first terminal and the second terminal is the same or similar, at which time the CBR measurement value measured at the second terminal is used as the CBR measurement value at the first terminal, or the CBR measurement value measured at the second terminal is used as an approximation of the CBR measurement value at the first terminal.

In another example, the network device receives the channel congestion condition transmitted by the second terminal through uplink.

In one example, the channel congestion condition is obtained by performing a CBR measurement on at least one specified channel.

In this embodiment of the present application, a CBR measurement value is based on a measurement on a specified channel in a specified sidelink resource pool, such as any one of a Physical Sidelink Share Channel (PSSCH), a Physical Sidelink Control Channel (PSCCH), and a Physical Sidelink Feedback Channel (PSFCH). Alternatively, the CBR measurement value is based on a measurement on a plurality of specified channels, for example, the measurement value is obtained by measuring PSSCH and PSCCH together in a resource pool.

In one example, the network device generates the channel congestion condition based on the CBR measurement value, the channel congestion condition being used to indicate the sidelink strategy corresponding to the CBR measurement value.

Here, the sidelink strategy is associated with sensing and/or selecting a sidelink resource.

In one example, the sidelink strategy is a strategy for selecting resources for sidelink. The sidelink strategy includes a first sidelink strategy and/or a second sidelink strategy. The resources being sensed under the first sidelink strategy are less than the resources being sensed under the second sidelink strategy.

In one example, the first sidelink strategy is also referred to as power-saving mode and the second sidelink strategy is also referred to as non-power-saving mode. The first terminal consumes less energy for sidelink transmission in power-saving mode compared to sidelink transmission in non-power-saving mode.

In one example, the channel congestion condition includes at least one of: a CBR measurement value, and an indicator of the sidelink strategy for the first terminal. Here, the indicator of the sidelink strategy for the first terminal is used to indicate a sidelink strategy corresponding to the CBR measurement value.

In an exemplary embodiment of embodiments of the present application, the network device adds the CBR measurement value directly to the channel congestion condition.

In an exemplary embodiment of embodiments of the present application, the network device determines the sidelink strategy based on the CBR measurement value and adds an indicator of the determined sidelink strategy to the channel congestion condition.

In one example, in the case that the indicator of the sidelink strategy will be included in the channel congestion condition, in the process of generating the channel congestion condition, the network device selects the sidelink strategy based on a relationship between a channel congestion condition and a congestion threshold. For example, the network device determines the sidelink strategy based on the relationship between the CBR measurement value and a measurement threshold.

In one example, the above-mentioned selection of the sidelink strategy based on the relationship between the channel congestion condition and the congestion threshold, includes:
determining, in response to the channel congestion condition not reaching a congestion threshold, the first sidelink strategy as the sidelink strategy;
determining, in response to the channel congestion condition reaching a congestion threshold, the second sidelink strategy as the sidelink strategy.

Here, the above congestion threshold for determining the first sidelink strategy is the same as or different from the congestion threshold for determining the second sidelink strategy.

In one example, the above-mentioned congestion thresholds include a first congestion threshold and a second congestion threshold, the first congestion threshold being less than or equal to the second congestion threshold. When the channel congestion condition does not reach the first congestion threshold, the first sidelink strategy is determined as the sidelink strategy. When the channel congestion condition reaches the second congestion threshold, the second sidelink strategy is determined as the sidelink strategy.

Taking the channel congestion condition being obtained by the measurement of CBR, the first congestion threshold being the first measurement threshold, and the second congestion threshold being the second measurement threshold, as an example, in this embodiment of the this application, when the CBR measurement value is less than the first measurement threshold, for example, when the CBR measurement value is less than 0.4, the network device considers that most of the sidelink resources are currently unoccupied. In this case, the first terminal, by sensing a small number of resources or not sensing, will have a high probability to select idle sidelink resources for sidelink transmission. Therefore, the network device determines the first sidelink strategy as the sidelink strategy.

Accordingly, when the CBR measurement value is not less than the second measurement threshold, for example, when the CBR measurement value is not less than 0.6, the network device considers that most of the sidelink resources are currently occupied. In this case, the first terminal, by sensing a small number of resources or not sensing, is likely to select no idle resources. Therefore, the network device determines the second sidelink strategy as the sidelink strategy.

In this embodiment of the present application, when the first terminal moves from the state where the energy-saving optimization scheme can be used (e.g., state 1 corresponding to the first sidelink strategy described above) to the state where the energy-saving optimization scheme cannot be used (e.g., state 2 corresponding to the second sidelink strategy described above), a measurement threshold, which is different from the one used when the first terminal moves from state 2 to state 1, is used in order to prevent the Ping-Pong effect. For example, if the first terminal is currently in a state where the energy-saving optimization can be used (e.g., state 1), the first terminal enters a state where the energy-saving optimization cannot be used (e.g., state 2) only when the CBR measurement value exceeds the predetermined threshold 1. However, if the first terminal is currently in a state where the energy-saving optimization cannot be used (e.g., state 2), the first terminal uses the energy-saving optimization (i.e., enters state 1) only when the CBR measurement value is less than the predetermined threshold 2. Here, the predetermined threshold 1 is greater than the predetermined threshold 2.

The above scheme is introduced with the first measurement threshold of 0.4 and the second measurement threshold of 0.6 as an example. In other implementations, the first measurement threshold and the second measurement threshold can take values other than 0.4 and 0.6, as long as the first measurement threshold is less than or equal to the second measurement threshold. For example, the first measurement threshold and the second measurement threshold are both 0.4, or both 0.5, etc.

When the first measurement threshold and the second measurement threshold are the same, the first measurement threshold and the second measurement threshold are in fact one and the same, i.e., the system contains one measurement threshold that is used as the first measurement threshold and also as the second measurement threshold.

In one example, the network device also performs the following steps:
obtaining the congestion threshold set in advance;
or
receiving the congestion threshold configured by the base station via downlink signaling.

In one exemplary scenario, the above congestion thresholds (e.g., the first congestion threshold and the second congestion threshold described above) are thresholds specified by the communication protocol. For example, the congestion threshold is factory-set in the network device, or, the congestion threshold is updated when the system is upgraded.

In another exemplary scenario, when the network device is a second terminal, the above congestion thresholds are statically, semi-statically or dynamically configured by the base station to the network device.

In one example, the congestion threshold is a threshold that corresponds to a priority of sidelink data to be sent from the first terminal.

Taking the channel congestion condition being obtained by measurement of the CBR, the first congestion threshold being the first measurement threshold, and the second congestion threshold being the second measurement threshold, as an example, in this embodiment of the present application, the measurement threshold corresponding to the CBR measurement value may be different for different priorities. Typically, the higher the priority of the sidelink data to be sent from the first terminal, the higher the CBR measurement threshold is set accordingly, which means that when the channel is relatively congested, the terminal that needs to save energy will use the energy-saving optimization scheme that may cause more transmission collisions and interference, only when transmitting higher priority data.

In one example, the network device is pre-configured with the congestion thresholds corresponding to different priorities through the base station or communication protocol. Taking location reporting service and power reporting service as an example, the service priority of the location reporting service is high and the service priority of the power reporting service is low. Further, in the case of the congestion threshold being a single threshold, the network device is pre-configured with the congestion threshold corresponding to the location reporting service is 0.5 and the congestion threshold corresponding to the power reporting service is 0.3. That is, if the current service of the first terminal is the location reporting service, the first terminal can use the first sidelink strategy (i.e., using the energy-saving optimization scheme) when the CBR measurement value is less than 0.5, while if the current service of the first terminal is the power reporting service, the first terminal can use the first sidelink strategy only when the CBR measurement value is less than 0.3.

For example, for a cluster of UEs, the UEs of high priority services can cause collisions, while the UEs of low priority services try to avoid collisions. According to the above scheme, in this application, the UEs of low priority services are controlled in the state of no energy-saving optimization (i.e., the second sidelink strategy), that is, the UEs should sense more channel situation to avoid conflicts as much as possible, while the UEs of high priority do not need to maintain the second strategy and can enter the energy-saving optimization state (i.e., the first sidelink strategy), so that the UEs continue to occupy resources in the case of less sensing or not sensing, which ensures the priority of high-priority services (i.e., the timely transmission of high-priority services).

Step 502, sending, by the network device, the channel congestion condition to the firs terminal. According, the first terminal receives the channel congestion condition.

In one example, when the network device is a base station, the base station sends the channel congestion condition to the first terminal via first signaling, and accordingly, the first terminal receives the channel congestion condition sent by the base station via the first signaling. The first signaling including at least one of a radio resource control (RRC) signaling and downlink control information (DCI).

In another example, when the network device is a second terminal, the second terminal sends the channel congestion condition to the first terminal via second signaling, and accordingly, the first terminal receives the channel congestion condition sent by the second terminal via the second signaling. The second signaling includes at least one of Physical layer control information for sidelink, MAC layer control information for sidelink, and RRC layer control information for sidelink.

In this embodiment of the present application, when the first sidelink strategy is used on the first terminal, the first terminal stops the CBR measurement for energy saving. In this case, the first terminal cannot obtain the channel congestion condition by itself, and thus, the channel congestion condition needs to be provided to the first terminal after the CBR measurement is performed by the base station or the second terminal. Here, the second terminal is a terminal using the second sidelink strategy, or the second terminal is a terminal that does not require energy saving, e.g., the second terminal is RSU equipment which is fixedly installed and has a stable power supply system.

The above steps 501-502 are alternative steps. In another example, the channel congestion condition is measured and generated by the first terminal itself through channel condition measurement, such as CBR measurement.

The process of obtaining the CBR measurement value and generating the channel congestion condition by the first terminal is similar to the process of obtaining the CBR measurement and generating the channel congestion condition by the network device as described above and will not be repeated here.

In one example, the first terminal obtains the congestion threshold set in advance, or the first terminal receives downlink signaling from the base station and obtains the congestion threshold based on the downlink signaling.

In one example, the first terminal selects the corresponding congestion threshold based on a priority of sidelink data to be sent from the first terminal.

In one example, the first terminal obtains a predetermined correspondence between the priority and the congestion threshold, or, the first terminal receives the downlink signaling from the base station and obtains the correspondence between the priority and the congestion threshold based on the downlink signaling.

In other words, the congestion threshold in the first terminal is pre-configured in the first terminal, or, the congestion threshold in the first terminal is received after it is configured by the base station via downlink signaling, and accordingly, the base station pre-configures the congestion threshold to the first terminal via downlink signaling. In one embodiment, the first terminal is provided with congestion thresholds corresponding to different priorities configured in advance by the base station or the communication protocol.

In one example, when the first terminal is unable to perform the CBR measurement due to the need for energy saving, the first terminal determines whether to use the energy-saving scheme according to a default configuration. The default configuration may be predefined or pre-configured by protocol, or configured through the downlink signaling of the base station.

In an exemplary embodiment, when the first sidelink strategy is used in the first terminal, the first terminal obtains a measurement configuration parameter that is used to indicate the timing of the CBR measurement, and performs the CBR measurement according to the timing of the CBR measurement. For example, when the timing of the CBR measurement arrives, the first sidelink strategy is disabled for starting the CBR measurement.

In an exemplary embodiment, when the network device is a base station, the measurement configuration parameter is sent to the first terminal via downlink signaling. The measurement configuration parameter is used to indicate the timing of the CBR measurement at the first terminal. Accordingly, the first terminal receives the measurement configuration parameter from the base station.

For example, when the first terminal is in the energy-saving state (i.e., the above-mentioned first sidelink strategy), a timer or measurement period is configured for the first terminal. The first terminal exits from the energy-saving state for CBR measurement every given length of time, or when the timer expires after a given length of time, and the first terminal determines whether to re-enter the energy-saving state based on the CBR measurement result. The CBR threshold, the measurement period, or the timer length, used in above determination of whether to re-enter the energy-saving state, is pre-configured or configured by downlink signaling of the base station.

S503, selecting, by the first terminal, a sidelink strategy based on the channel congestion condition.

In one example, when the channel congestion condition directly contains an indicator of the sidelink strategy, the first terminal directly obtains the sidelink strategy based on the indicator in the channel congestion condition.

In another example, the first terminal selects the sidelink strategy based on a relationship between the channel congestion condition and a congestion threshold.

For example, when the channel congestion condition does not directly include an indicator of the sidelink strategy, but instead includes the CBR measurement value as described above, the first terminal determines the sidelink strategy based on the CBR measurement value.

In one example, the first terminal determines that the sidelink strategy is the first sidelink strategy when the channel congestion condition does not reach a congestion threshold; and
when the channel congestion condition reaches a congestion threshold, the first terminal determines that the sidelink strategy is the second sidelink strategy.

In one example, the first terminal obtains a congestion threshold set in advance;
or, the first terminal receives downlink signaling from the base station and obtains the congestion threshold based on the downlink signaling. In one example, the congestion threshold is sent to the first terminal via downlink signaling when the network device is a base station.

In one example, the first terminal selects a corresponding congestion threshold based on a priority of sidelink data to be sent from the first terminal.

In one example, the first terminal obtains a predetermined correspondence between the priority and the congestion threshold; or
the first terminal receives downlink signaling from the base station and obtains a correspondence between the priority and the congestion threshold based on the downlink signaling. In one example, the correspondence between the priority and the congestion threshold is sent to the first terminal via downlink signaling, when the network device is a base station.

Step 504, selecting, by the first terminal, a communication resource for sidelink transmission based on the sidelink strategy.

The communication resource includes at least one of a time resource, a frequency resource, and a port resource.

In one example, the first sidelink strategy includes:
sensing part of resources in a sidelink resource pool, and selecting a target sidelink resource from the part of resources based on a sensing result;
or,
randomly selecting a target sidelink resource from a sidelink resource pool.

In one example, the second sidelink strategy includes:
sensing all resources in a sidelink resource pool, and selecting a target sidelink resource from the sidelink resource pool based on a sensing result.

In one example, the first terminal selects the target sidelink resource based on the channel congestion condition by:
obtaining a resource selection method when the sidelink strategy is the first sidelink strategy, and selecting the target sidelink resource from the sidelink resource pool according to the resource selection method.

In one example of this application, there are two or more resource selection methods to select the sidelink resource for the first strategy which is more power saving, accordingly, when the first terminal determines to use the first sidelink strategy for sidelink transmission, it first obtains the resource selection method.

In one example, the step of obtaining the resource selection method when the sidelink strategy is the first sidelink strategy may include:
when the sidelink strategy is the first sidelink strategy and the channel congestion condition contains the CBR measurement value, the first terminal obtains the resource selection method corresponding to the CBR measurement value;
or,
the first terminal obtains the resource selection method contained in the channel congestion condition.

In an exemplary embodiment, the CBR measurement value is related to the resource selection method under the first sidelink strategy. That is, when the channel congestion condition contains the CBR measurement value, the first terminal queries the correspondence between the CBR measurement value and the resource selection method according to the CBR measurement value. For example, the measurement value intervals corresponding to various resource selection methods are predetermined in the first terminal, after the first terminal obtains the channel congestion condition containing the CBR measurement value, it determines the measurement value interval in which the CBR measurement value is located, and then determines the resource selection method corresponding to the measurement value interval.

In another exemplary embodiment, the resource selection method is carried directly in the channel congestion condition. For example, when the channel congestion condition is the information sent by the network device, the network device determines the resource selection method corresponding to the CBR measurement value according to the predetermined measurement value intervals respectively corresponding to various resource selection methods when generating the channel congestion condition, and adds the determined resource selection method to the channel congestion condition.

Step 505, determining, by the first terminal, a limitation on a value of a sidelink data transmission parameter based on the sidelink strategy.

In one example of this application, the limitation on the value of the sidelink data transmission parameter is indicated by a congestion control configuration. The congestion control configuration includes a configuration of mapping relationships between different CBR measurement values and limitations of sidelink data transmission parameter of the terminal.

In one example, the limitation on the value of the sidelink data transmission parameter includes at least one of:
a maximum allowed transmitting power;
an available modulation coding method;
a maximum number of time resources and/or frequency resources occupied by a single transmission;
a maximum number of times for retransmission of a data block; and
an upper limit of a Channel Occupancy Ratio (CR).

By limiting the value of the user's sidelink data transmission parameter, the efficiency and number of the sidelink time/frequency resources used by the terminal can be controlled, so as to achieve the purpose of reducing the time/frequency resources occupied by the terminal for sidelink, and then reducing congestion. For example, when the CBR measurement value indicates that the current channel is congested, the terminal can be limited to use higher Modulation and Coding Scheme (MCS), e.g., using higher MCS for the same load size will occupy less time/frequency resources, thus reducing the probability of collision between terminals for sidelink transmission, or the terminal can be limited to use lower maximum transmitting power to reduce interference between terminals, or the upper limit on the ratio of sidelink time/frequency resources, that can be occupied by the terminal's sidelink transmission of data of a given priority, is directly limited.

In one example, said determining the limitation on the value of the sidelink data transmission parameter based on the sidelink strategy, includes:
determining a transmission parameter mapping relationship based on the sidelink strategy, the transmission parameter mapping relationship including a correspondence between the channel congestion condition and the limitation on the value of the sidelink data transmission parameter; and
querying the transmission parameter mapping relationship and obtaining the limitation on the value of the sidelink data transmission parameter that corresponds to the channel congestion condition.

In one example, the transmission parameter mapping relationship contains transmission parameter sub-tables respectively corresponding to various resource selection methods under the first sidelink strategy, and accordingly, when the first terminal determines that the sidelink strategy is the first sidelink strategy, it also selects the transmission parameter sub-table according to the corresponding resource selection method and queries the selected transmission parameter sub-table for the limitation on the value of the sidelink data transmission parameter through the channel congestion condition (e.g. the CBR measurement value).

In one example, the first terminal also receives downlink signaling from the base station and obtains the transmission parameter mapping relationship based on the downlink signaling. Accordingly, when the network device is a base station, the network device sends the transmission parameter mapping relationship corresponding to the sidelink strategy to the first terminal via downlink signaling.

Alternatively, in another example, the transmission parameter mapping relationships corresponding to the various sidelink strategies are predetermined in the first terminal.

In this embodiment of the present application, the base station can independently configure the congestion control when the terminal uses a sidelink strategy through downlink signaling. It is also possible to independently pre-configure the congestion control when the terminal uses different sidelink strategies. For example, a set of mappings between CBR measurement values and ranges of values of the terminal's sidelink data transmission parameters is configured for resource selection based on energy-saving optimization (e.g., resource selection based on partial sensing or random selection based on no sensing), and another set of mappings between CBR measurement values and ranges of values of the terminal's sidelink data transmission parameters is configured for resource selection without energy-saving optimization, and the terminal selects an appropriate set of mappings according to the resource selection method of its own sidelik transmission.

Step 506, performing sidelink data transmission on the target sidelink resource according to the limitation on the value of the sidelink data transmission parameter.

After the first terminal determines the target sidelink resource and determines the limitation on the value of the sidelink data transmission parameter, it can perform the transmission of the sidelink data by combining the target sidelink resource and the limitation on the value of the sidelink data transmission parameter.

In view of above, in the scheme described in the embodiments of the present application, the terminal selects, based on the channel congestion condition, a sidelink strategy from two sidelink strategies with different amounts of resources sensed, so as to subsequently select resources for sidelink based on the selected strategy. That is, by using the above scheme, the terminal can be indicated through the channel congestion condition to use the sidelink modes with different amounts of resources sensed. Since the less resources are sensed, the corresponding power consumption of sensing is lower, the above scheme can reduce the power consumption of the terminal during sidelink transmission while avoiding channel collisions as much as possible.

The following description is for device embodiments of the present disclosure that can be used to perform method embodiments of the present disclosure. For details not disclosed in these device embodiments, please refer to the method embodiments of the present disclosure.

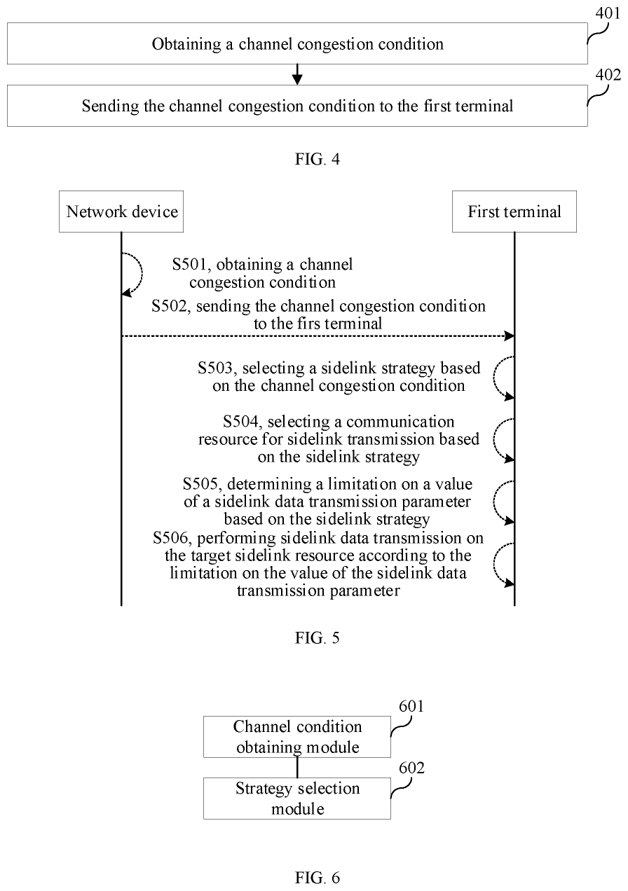

FIG. 6 is a block diagram of a sidelink apparatus illustrated in accordance with an exemplary embodiment. As shown in FIG. 6, the sidelink apparatus may perform the steps performed by a first terminal in the embodiment shown in FIG. 2 or FIG. 5. The sidelink apparatus may include:
a channel condition obtaining module 601 configured to obtain a channel congestion condition; and
a strategy selection module 602 configured to select a sidelink strategy based on the channel congestion condition, wherein the sidelink strategy is associated with sensing and/or selecting a sidelink resource.

In one example, the sidelink strategy is a strategy for selecting resources for sidelink. The sidelink strategy includes a first sidelink strategy and/or a second sidelink strategy. The resources being sensed under the first sidelink strategy are less than the resources being sensed under the second sidelink strategy.

In one example, the strategy selection module is configured to select the sidelink strategy based on a relationship between the channel congestion condition and a congestion threshold.

In one example, the strategy selection module is configured to:
select a first sidelink strategy in response to the channel congestion condition not reaching a congestion threshold; or
select a second sidelink strategy in response to the channel congestion condition reaching a congestion threshold.

In one example, resources being sensed under the first sidelink strategy are less than resources being sensed under the second sidelink strategy.

In one example, the channel congestion condition is obtained by performing a Channel Busy Ratio (CBR) measurement on at least one specified channel.

In one example, the channel congestion condition is obtained by a measurement of a network device; and
the channel condition obtaining module is configured to receive the channel congestion condition from the network device.

In one example, the channel congestion condition comprises an indicator of the sidelink strategy for the first terminal.

In one example, the network device is a base station, and the channel condition obtaining module is configured to:
receive the channel congestion condition sent by the base station via first signaling, the first signaling comprises at least one of a radio resource control (RRC) signaling and downlink control information (DCI).

In one example, the network device is a second terminal, and the channel condition obtaining module is configured to:
receive the channel congestion condition sent by the second terminal via second signaling, the second signaling comprises at least one of Physical layer control information for sidelink, MAC layer control information for sidelink, and RRC layer control information for sidelink.

In one example, the apparatus further includes: a first threshold obtaining module, or, a second threshold obtaining module;
the first threshold obtaining module is configured to obtain the congestion threshold set in advance; and
the second threshold obtaining module is configured to receive downlink signaling from a base station and obtain the congestion threshold based on the downlink signaling.

In one embodiment, the apparatus further includes:
a threshold selection module configured to select a corresponding congestion threshold based on a priority of sidelink data to be sent from the first terminal.

In one example, the apparatus further includes: a first correspondence obtaining module, or, a second correspondence obtaining module;
the first correspondence obtaining module configured to obtain a predetermined correspondence between the priority and the congestion threshold; and
the second correspondence obtaining module configured to receive downlink signaling from a base station and obtain a correspondence between the priority and the congestion threshold based on the downlink signaling.

In one embodiment, the apparatus further includes:
a configuration parameter obtaining module configured to obtain a measurement configuration parameter, the measurement configuration parameter being configured to indicate timing of the CBR measurement; and
a measurement module configured to perform the CBR measurement according to the timing of the CBR measurement.

In one example, the first sidelink strategy includes:
sensing part of resources in a sidelink resource pool, and selecting a target sidelink resource from the part of resources based on a sensing result;
or,
randomly selecting a target sidelink resource from a sidelink resource pool.

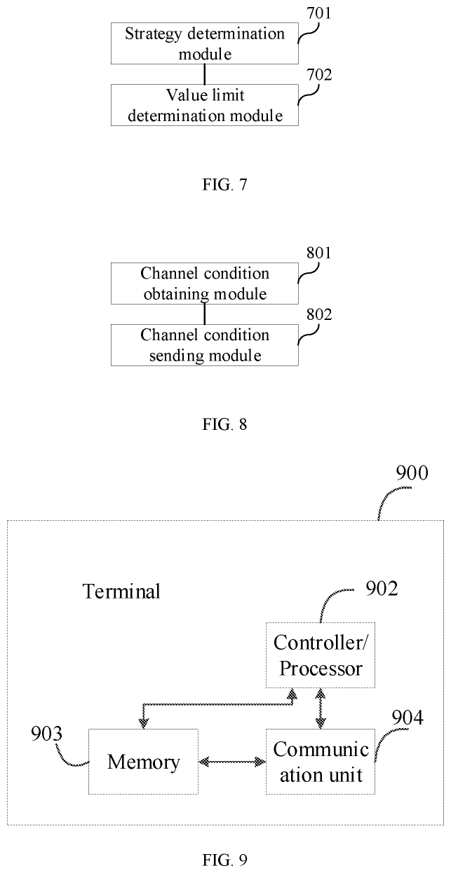

FIG. 7 is a block diagram of a congestion control apparatus for sidelink illustrated in accordance with an exemplary embodiment. As shown in FIG. 7, the congestion control apparatus for sidelink may perform the steps performed by a first terminal in the embodiment shown in FIG. 3 or FIG. 5. The congestion control apparatus for sidelink may include:
a strategy determination module 701 configured to determine a sidelink strategy, the sidelink strategy being associated with sensing and/or selecting a sidelink resource; and
a value limit determination module 702 configured to determine a limitation on a value of a sidelink data transmission parameter based on the sidelink strategy.

In one example, the sidelink strategy comprises a first sidelink strategy and/or a second sidelink strategy; and resources being sensed under the first sidelink strategy are less than resources being sensed under the second sidelink strategy.

In one embodiment, the apparatus further includes:
a communication resource determination module configured to select a communication resource for sidelink transmission based on the sidelink strategy,
wherein the communication resource comprises at least one of a time resource, a frequency resource, and a port resource.

In one example, the value limit determination module is configured to:
determine a transmission parameter mapping relationship based on the sidelink strategy, the transmission parameter mapping relationship comprising a correspondence between the channel congestion condition and the limitation on the value of the sidelink data transmission parameter; and
query the transmission parameter mapping relationship and obtain the limitation on the value of the sidelink data transmission parameter that corresponds to the channel congestion condition.

In one embodiment, the apparatus further includes:
a mapping relationship obtaining module configured to receive downlink signaling from a base station, and obtain the transmission parameter mapping relationship based on the downlink signaling.

In one example, the limitation on the value of the sidelink data transmission parameter comprises at least one of:
a maximum allowed transmitting power;
an available modulation coding method;
a maximum number of time resources and/or frequency resources occupied by a single transmission;
a maximum number of times for retransmission of a data block; and
an upper limit of a Channel Occupancy Ratio (CR).

FIG. 8 is a block diagram of a sidelink apparatus illustrated in accordance with an exemplary embodiment. As shown in FIG. 8, the sidelink apparatus may perform the steps performed by a network device in the embodiment shown in FIG. 4 or FIG. 5. The sidelink apparatus may include:
a channel condition obtaining module 801 configured to obtain a channel congestion condition; and
a channel condition sending module 802 configured to send the channel congestion condition to a first terminal for determining a sidelink strategy, the sidelink strategy being associated with sensing and/or selecting a sidelink resource.

In a example, the channel congestion condition is obtained by performing a CBR measurement on at least one specified channel.

In one example, the channel congestion condition comprises an indicator of the sidelink strategy for the first terminal; the sidelink strategy comprises a first sidelink strategy and/or a second sidelink strategy; and resources being sensed under the first sidelink strategy are less than resources being sensed under the second sidelink strategy.

In one example, the network device is a base station, and the channel condition sending module is configured to:
send the channel congestion condition to the first terminal via first signaling, the first signaling comprising at least one of a radio resource control (RRC) signaling and downlink control information (DCI).

In one example, the network device is a second termina, and the channel condition sending module is configured to:
send the channel congestion condition to the first terminal via second signaling, the second signaling comprising at least one of Physical layer control information for sidelink, MAC layer control information for sidelink, and RRC layer control information for sidelink.

In one example, the network device is a base station, and the apparatus further includes:
a threshold sending module configured to send a congestion threshold to the first terminal via downlink signaling.

In one example, the network device is a base station, and the apparatus further includes:
a correspondence sending module configured to send the first terminal a correspondence between a priority and a congestion threshold via downlink signaling, wherein the priority is a priority of sidelink data to be sent from the first terminal.

In one example, the network device is a base station, and the apparatus further includes:
a configuration parameter sending module configured to send the first terminal a measurement configuration parameter via downlink signaling, the measurement configuration parameter being configured to indicate to the first terminal timing of a Channel Busy Ratio (CBR) measurement.

In one example, the network device is a base station, and the apparatus further includes:
a mapping relationship sending module configured to send the first terminal a transmission parameter mapping relationship corresponding to the sidelink strategy via downlink signaling.

An exemplary embodiment of the present disclosure also provides a sidelink system, the system including at least one first terminal and a network device.

The terminal includes at least one of a sidelink apparatus as provided in the embodiment shown in FIG. 6, and a congestion control apparatus for sidelink as provided in the embodiment shown in FIG. 7.

The base station includes a sidelink apparatus as provided in the embodiment shown in FIG. 8.

It should be noted that the apparatus provided by the above embodiments is only illustrated by the above-mentioned division of each functional module in realizing its functions. In actual application, the above functions can be assigned by different functional modules according to actual needs, i.e., the content structure of the apparatus is divided into different functional modules to accomplish all or part of the above described functions.

Regarding the apparatus in the above embodiments, the specific way in which each module performs its operation has been described in detail in the embodiments concerning the method, and will not be described in detail here.

An exemplary embodiment of the present disclosure provides a sidelink device which can implement all or some of the steps performed by a first terminal in the embodiment shown in FIG. 2 or FIG. 5 above of the present disclosure. The sidelink device includes: a processor, and a memory for storing instructions executable by the processor;
where the processor is configured to:
obtain a channel congestion condition; and
select a sidelink strategy based on the channel congestion condition, wherein the sidelink strategy is associated with sensing and/or selecting a sidelink resource.

An exemplary embodiment of the present disclosure provides a congestion control device for sidelink which can implement all or some of the steps performed by a first terminal in the embodiment shown in FIG. 3 or FIG. 5 above of the present disclosure. The congestion control device for sidelink includes: a processor, and a memory for storing instructions executable by the processor;
where the processor is configured to:
determine a sidelink strategy, the sidelink strategy being associated with sensing and/or selecting a sidelink resource; and
determine a limitation on a value of a sidelink data transmission parameter based on the sidelink strategy.

An exemplary embodiment of the present disclosure provides a sidelink device which can implement all or some of the steps performed by a network device in the embodiment shown in FIG. 4 or FIG. 5 above of the present disclosure. The sidelink device includes: a processor, and a memory for storing instructions executable by the processor;
where the processor is configured to:
obtain a channel congestion condition; and
send the channel congestion condition to a first terminal for determining a sidelink strategy, the sidelink strategy being associated with sensing and/or selecting a sidelink resource.

The solutions provided by embodiments of the present disclosure are described above, mainly using terminals and network devices as examples. It will be understood that the user device, in order to achieve the above functions, contains hardware structures and/or software modules corresponding to the execution of each function. In conjunction with the modules and algorithmic steps of each example described in the embodiments disclosed in the present disclosure, embodiments of the present disclosure are capable of being implemented in the form of hardware or a combination of hardware and computer software. Whether a particular function is performed as hardware or computer software driving hardware depends on the particular application and design constraints of the technical solution. A person skilled in the art may use a different approach for each particular application to implement the described functionality, but such implementation should not be considered beyond the scope of the technical solutions of the embodiments of the present disclosure.

FIG. 9 is a schematic diagram of a structure of a terminal illustrated in accordance with an exemplary embodiment. The terminal may be realized as a first terminal in the embodiment shown above in FIG. 2, FIG. 3 or FIG. 5.

The terminal 900 includes a communication unit 904 and a processor 902, where the processor 902 may also be a controller, indicated as “controller/processor 902” in FIG. 9. The communication unit 904 is used to support communication between the terminal and other network entities (e.g., other terminals or network devices, etc.).

Further, the terminal 900 may also include a memory 903, which is used to store the program code and data of the terminal 900.

It will be appreciated that FIG. 9 illustrates only a simplified design of the terminal 900. In practical applications, the terminal 900 may contain any number of processors, controllers, memories, communication units, etc., and all terminals that can implement embodiments of the present disclosure are within the scope of protection of embodiments of the present disclosure.

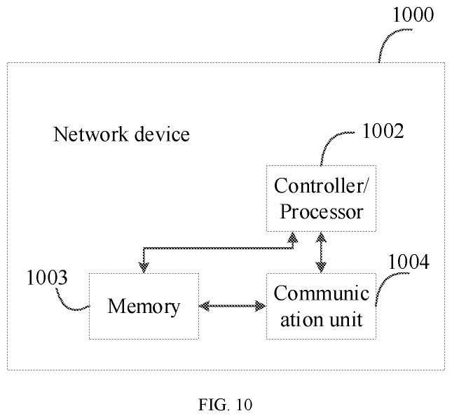

FIG. 10 is a schematic diagram of a structure of a network device illustrated according to an exemplary embodiment. The network device may be implemented as the network device in the embodiment shown in FIG. 4 or FIG. 5 above.

The network device 1000 includes a communication unit 1004 and a processor 1002, where the processor 1002 may also be a controller, indicated as “controller/processor 1002” in FIG. 10. The communication unit 1004 is used to support communication between the network device and other network entities (e.g., other terminals or base stations, etc.).

Further, the network device 1000 may also include a memory 1003, which is used to store program code and data of the network device 1000.

It will be appreciated that FIG. 10 illustrates only a simplified design of the network device 1000. In practice, the network device 1000 may contain any number of processors, controllers, memory, communication units, etc., and all network devices that can implement embodiments of the present disclosure are within the scope of protection of embodiments of the present disclosure.

One of skill in the art should be aware that in one or more of the above examples, the functions described in embodiments of the present disclosure may be implemented with hardware, software, firmware, or any combination thereof. When implemented using software, these functions may be stored in a computer-readable medium or transmitted as one or more instructions or code on a computer-readable medium. The computer-readable medium includes computer storage medium and communication medium, where communication medium includes any medium that facilitates the transmission of computer programs from one place to another. The storage medium may be any available medium accessible to a general purpose or specialized computer.

Embodiments of the present disclosure also provide a computer storage medium for storing executable instructions for use by the terminal or base station, and a processor in the communication device invokes the executable instructions to implement all or some of the steps performed by the first terminal or network device in the method shown in any of the above embodiments.

Embodiments of the present disclosure also provide a computer program product, the computer program product including computer instructions, the computer instructions being stored in a computer-readable storage medium. A processor of the communication device may read the computer instructions from the computer readable storage medium, and the processor executes the computer instructions such that the computer device implements the method described above.

Other embodiments of the present disclosure will readily occur to those skilled in the art upon consideration of the specification and practice of the application disclosed herein. This application is intended to cover any variations, uses, or adaptations of the present disclosure that follow the general principles of the present disclosure and include common knowledge or techniques in the technical field not disclosed by the present disclosure. The specification and examples are to be regarded as exemplary only, and the true scope and spirit of the disclosure being indicated by the following claims.

It should be understood that the embodiments of the present disclosure are not limited to the precise structures described above and illustrated in the accompanying drawings, and that various modifications and changes may be made without departing from the scope thereof. The scope of the present application is limited only by the scope of the appended claims.

1. A sidelink method, comprising:
obtaining, by a first terminal, a channel congestion condition; and
selecting, by the first terminal, a sidelink strategy based on the channel congestion condition, wherein the sidelink strategy is associated with sensing a sidelink resource, selecting the sidelink resource, or sensing and selecting the sidelink resource.

2. The method of claim 1, wherein selecting the sidelink strategy based on the channel congestion condition comprises:
selecting the sidelink strategy based on a relationship between the channel congestion condition and a congestion threshold.

3. The method of claim 2, wherein selecting the sidelink strategy based on the relationship between the channel congestion condition and the congestion threshold, comprises:
selecting a first sidelink strategy in response to the channel congestion condition not reaching a congestion threshold; or
selecting a second sidelink strategy in response to the channel congestion condition reaching a congestion threshold;
wherein resources being sensed under the first sidelink strategy are less than resources being sensed under the second sidelink strategy.

4. (canceled)

5. The method of claim 1, wherein the channel congestion condition is obtained by a measurement of a network device; and
obtaining the channel congestion condition comprises:
receiving the channel congestion condition from the network device.

6. (canceled)

7. The method of any one of claim 5, wherein the network device is a base station, and receiving the channel congestion condition from the network device comprises:
receiving the channel congestion condition sent by the base station via first signaling, the first signaling comprises at least one of a radio resource control (RRC) signaling or downlink control information (DCI).

8. The method of claim 5, wherein the network device is a second terminal, and receiving the channel congestion condition from the network device comprises:
receiving the channel congestion condition sent by the second terminal via second signaling, the second signaling comprises at least one of following information: Physical layer control information for sidelink, MAC layer control information for sidelink, or RRC layer control information for sidelink.

9. (canceled)

10. The method of claim 2, further comprising:
selecting a corresponding congestion threshold based on a priority of sidelink data to be sent from the first terminal.

11. The method of claim 10, further comprising:
obtaining, by the first terminal, a predetermined correspondence between the priority and the congestion threshold; or,
receiving, by the first terminal, downlink signaling from a base station and obtaining a correspondence between the priority and the congestion threshold based on the downlink signaling.

12. (canceled)

13. The method of claim 1, wherein the first sidelink strategy comprises:
sensing part of resources in a sidelink resource pool, and selecting a target sidelink resource from the part of resources based on a sensing result; or,
randomly selecting a target sidelink resource from a sidelink resource pool.

14. A congestion control method for sidelink, comprising:
determining, by a first terminal, a sidelink strategy, wherein the sidelink strategy is associated with sensing a side link resource, selecting the sidelink resource, or sensing and selecting the sidelink resource; and
determining, by the first terminal, a limitation on a value of a sidelink data transmission parameter based on the sidelink strategy.

15. The method of claim 14, wherein
the sidelink strategy comprises a first sidelink strategy or a second sidelink strategy; and resources being sensed under the first sidelink strategy are less than resources being sensed under the second sidelink strategy.

16. The method of claim 14, further comprising:
selecting, by the first terminal, a communication resource for sidelink transmission based on the sidelink strategy,
wherein the communication resource comprises at least one of following resources: a time resource, a frequency resource, or a port resource.

17. The method of claim 14, wherein determining the limitation on the value of the sidelink data transmission parameter based on the sidelink strategy, comprises:
determining a transmission parameter mapping relationship based on the sidelink strategy, the transmission parameter mapping relationship comprising a correspondence between the channel congestion condition and the limitation on the value of the sidelink data transmission parameter; and
querying the transmission parameter mapping relationship and obtaining the limitation on the value of the sidelink data transmission parameter that corresponds to the channel congestion condition.

18. (canceled)

19. The method of claim 14, wherein the limitation on the value of the sidelink data transmission parameter comprises at least one of followings:
a maximum allowed transmitting power;
an available modulation coding method;
a maximum number of time resources or frequency resources occupied by a single transmission;
a maximum number of times for retransmission of a data block; and
an upper limit of a Channel Occupancy Ratio (CR).

20. A sidelink method, comprising:
obtaining, by a network device, a channel congestion condition; and
sending, by the network device, the channel congestion condition to a first terminal for determining a sidelink strategy, wherein the sidelink strategy is associated with sensing a sidelink resource, selecting the sidelink resource, or sensing and selecting the sidelink resource.

21. The method of claim 20, wherein
the channel congestion condition comprises an indicator of the sidelink strategy for the first terminal;
the sidelink strategy comprises a first sidelink strategy or a second sidelink strategy; and
resources being sensed under the first sidelink strategy are less than resources being sensed under the second sidelink strategy.

22. The method of claim 20, wherein in response to determining that the network device is a base station, sending the channel congestion condition to the first terminal for determining the sidelink strategy, comprises:
sending the channel congestion condition to the first terminal via first signaling, the first signaling comprising at least one of a radio resource control (RRC) signaling or downlink control information (DCI).

23. The method of claim 20, wherein in response to determining that the network device is a second terminal, sending the channel congestion condition to the first terminal for determining the sidelink strategy, comprises:
sending the channel congestion condition to the first terminal via second signaling, the second signaling comprising at least one of following information: Physical layer control information for sidelink, MAC layer control information for sidelink, or RRC layer control information for sidelink.

24. (canceled)

25. The method of claim 20, wherein in response to determining that the network device is a base station, the method further comprises:
sending by the network device, the first terminal a correspondence between a priority and a congestion threshold via downlink signaling, wherein the priority is a priority of sidelink data to be sent from the first terminal.

26-57. (canceled)

58. A non-transitory computer-readable storage medium, storing instructions, wherein when the instructions are executed by a processor, the processor implements a method of claim 1.
